(19) United States
(12) Patent Application Publication
(10) Pub. No.: US 2015/0276785 A1
(43) Pub. Date: Oct. 1, 2015

(54) METHOD FOR DETERMINING A SPEED OF A COMPRESSOR

(71) Applicant: Robert Bosch GmbH, Stuttgart (DE)

(72) Inventors: Michael Nau, Dornhan/Aischfeld (DE); Michael Baeuerle, Eberdingen (DE)

(21) Appl. No.: 14/412,128

(22) PCT Filed: May 28, 2013
(86) PCT No.: PCT/EP2013/060987

§ 371 Date: Apr. 13, 2015

(30) Foreign Application Priority Data
Jul. 2, 2012 (DE) 10 2012 211 425.4

(51) Int. Cl. G01P 3/44; F02B 37/00

(52) U.S. Cl. CPC G01P 3/44; F02B 37/00

(57) ABSTRACT

A method for determining a speed of a turbocharger of an internal combustion engine includes: recording, upstream of the compressor, a flow and/or a pressure of air supplied to the internal combustion engine and generating an associated flow signal and/or pressure signal; and ascertaining a rotational speed of the turbocharger from a periodic fluctuation of at least one portion of the flow signal and/or the pressure signal.

### BACKGROUND OF THE INVENTION

1. Field of the Invention

The present invention relates to a method for determining a rotational speed of a compressor, e.g., a turbocharger in an internal combustion engine.

2. Description of the Related Art

In internal combustion engines, for instance, gasoline and Diesel piston engines, to increase the performance, the air charge in a combustion chamber of the internal combustion engine is increased by the use of a compressor, such as an exhaust gas turbocharger. The pressure with which the air is pressed into the combustion chamber of the internal combustion engine is also designated as boost pressure, and is generally measured in the vicinity of the combustion chamber by a pressure sensor. The pressure signal is supplied to a closed control loop which controls the exhaust gas turbocharger and thereby sets a desired boost pressure.

In particular, exhaust gas turbochargers have a characteristic time constant, and thus they react comparatively sluggishly to changed control signals, which sluggish reaction makes the regulation of the boost pressure more difficult. Therefore, it is advantageous if a direct state variable of the exhaust gas turbocharger, that is to be regulated, is recorded. The rotary speed of the compressor of the exhaust gas turbocharger is particularly suitable for this. The knowledge of the compressor speed is of especial interest, since, in the case of operating a turbocharger, a certain maximum speed threshold may not be exceeded, since otherwise the turbocharger may be damaged conditioned upon the exceeding of critical stresses in the compressor wheel, a deformation of the compressor wheel which leads to the brushing of the rotor against the housing.

The compressor speed may be calculated, in principle, using a known compressor characteristics map, provided certain variables, such as the pressure before and after the compressor, the air mass flow through the compressor and the temperature before the compressor are known. With the aid of these variables, the position of an operating point in the compressor characteristics map is known and thus also the speed of the compressor, without a sensor having to be used in the speed determination.

To limit the speed of the exhaust gas turbocharger, an environmental pressure sensor is normally used. Typically, it is positioned in the engine control unit, in order to keep the wiring expenditure low. A problem, in this context, is the fact that different charging states of the air filter, such as wetness, ice or dirt, which jointly influence the air pressure that is relevant for the compressor of the exhaust gas turbocharger, are not taken into account. Therefore, in individual cases, this environmental pressure sensor is integrated into the air filter box. However, for the integration of the environmental pressure sensor into the air filter box, as opposed to mounting it in the engine control unit, an additional wiring expenditure is required. Additional factors determining the exhaust gas turbocharger speed, such as tolerances of pressure sensors, i.e. pressure sensors for the determination of the pressure of the environment as well as the boost pressure, and volumetric efficiency tolerances of the engine are not, and are not able to be recorded thereby.

As a result, the estimation of the speed of the exhaust gas turbocharger described above is subject to significant inaccuracies. Besides the tolerances of the abovementioned sensors, these are the inaccuracies in the compressor characteristics map, tolerances of the control times or modeling inaccuracies. Furthermore, it is the lack of knowledge of the exact loading state of the air filter. For instance, an air filter that is wet through and through leads to a considerable increase in the charger speed without this being taken into account by using the variables named before, when falling back on the compressor characteristics map. The charger speed also increases in response to leakages upstream of the compressor, without this being detected.

Because of the inaccuracy described of the estimated charger speed, and in order to avoid the exceeding of the maximum speed that is critical for strength reasons, in applications, these days, a safety distance of ca. 5% to 10% of the maximum rotary speed is held in reserve. This leads to the nominal power of the engine having to be limited, if necessary, already at geodetic sea level. In addition, at rising geodetic height, the maximum engine torque or the air charge required for this, is not able to be maintained to the same degree as would be possible in the case of a full utilization of the charger's maximum speed. These effects are becoming ever more relevant with the increasing booster grades and the additional lowering of the cubic capacity or increase in the degree of downsizing, which are currently observable. In addition, in the application approach described using a safety reserve, there is still no certain avoiding of booster overspeeding possible if the leakages set in downstream from the charger or if the pressure drop at the air filter rises greatly, for instance, as a result of a complete wetting or even freezing.

In order to avoid the safety distance from the maximum speed described and the disadvantages resulting from this, an exact measurement of the speed is required. For this purpose, various sensor concepts are known, such as inductive sensors and eddy-current sensors, which, because of the additional costs incurred, have, however, not yet experienced any spreading in the mass market of supercharged vehicle engines. In contrast to this, however, vehicle applications are known in which no speed sensor is used, it is true, but an additional pressure sensor is applied for measuring the pressure downstream from the air filter. With that, the charging state of the air filter may be recorded exactly, and the abovementioned method for determining the speed by falling back on the compressor characteristics map becomes more accurate. The effects of the sensor tolerances, the inaccuracies in the compressor characteristics map, the tolerances in the control times, the modeling inaccuracies as well as the effects of leakages on the charger speed are left intact, however. As a result, in this approach, the safety distance from the maximum speed may be reduced in a limited way, with the negative results described, but cannot be avoided.

Despite the numerous advantages of the methods known from the related art, for determining the rotational speed of a compressor, they consequently still include room for improvement.

### BRIEF SUMMARY OF THE INVENTION

Therefore, a method for determining a rotational speed of a compressor is provided, particularly of a turbocharger of an internal combustion engine and an internal combustion engine, which at least extensively avoid the disadvantages of known methods and strategies for determining the speed of a compressor, and using which, particularly the safety distance from the maximum speed of the compressor mentioned above is able to be avoided or at least clearly reduced. It is the aim of the present invention to determine the speed of the compressor without using an additional sensor.

The method for determining a rotational speed of a compressor, especially of a turbocharger of an internal combustion engine in which a flow signal of the air supplied to the internal combustion engine and a pressure signal are generated, the speed of the compressor being ascertained from a periodic fluctuation of at least one portion of the flow signal and/or the pressure signal, is distinguished by the flow and/or the pressure being recorded upstream of the compressor.

The internal combustion engine may include an air filter, the flow signal and/or the pressure being recorded in a region downstream from the air filter. From the pressure signal and a pressure signal of an environmental pressure sensor, a pressure difference or a pressure ratio may be determined, and from this, a functional state of the air filter may be determined. The periodic fluctuations may be separated from the flow signal and/or the pressure signal by high-pass filtering. A frequency of the periodic fluctuations is able to be ascertained by a frequency analysis, in particular a Fourier transformation. The speed of the compressor may be obtained by division of the frequency by the number of blades of the compressor. The speed of the compressor may be obtained from a periodic fluctuation of at least a portion of the flow signal and the pressure signal.

An internal combustion engine according to the present invention includes a compressor, which is situated in an air supply channel for supplying air to a combustion chamber of the internal combustion engine, a pressure sensor for recording a pressure of the air supplied to the combustion chamber and for generating an associated pressure signal and/or a flow sensor for recording the flow of air supplied to the combustion chamber and for generating an associated flow signal, the internal combustion engine furthermore including an evaluation circuit for determining the speed of the compressor, the speed of the compressor being able to be ascertained from a periodic fluctuation of at least one portion of the flow signal and/or the pressure signal in the air supply channel, in a region upstream of the compressor.

The evaluation circuit for determining the speed of the compressor may be situated in a control and/or regulation unit of the internal combustion engine, a sensor housing for the flow sensor and/or the pressure sensor or in a component separated from these. The internal combustion engine may include the flow sensor and the pressure sensor, the flow sensor and the pressure sensor being integrated in a common sensor housing.

Within the scope of the present invention, by a flow signal one should understand a signal that indicates any desired physically or chemically measurable property of a flow of air supplied to a combustion chamber of an internal combustion engine and qualifies or quantifies it. In particular, this may be about a flow speed and/or an air mass flow and/or an air volume flow. In other words, the flow signal is at least a signal selected from a mass flow signal, a volume flow signal and a flow speed signal. A mass flow is usually indicated in kg/h and states an air mass which flows through a measuring cross sectional area in a certain time. A volume flow is usually given in m³/h. A volume flow indicates an air volume which flows through a measuring cross sectional area in a certain time. The flow speed is usually given m/s. The flow properties recorded and converted to a signal, in particular, refer to periodically fluctuating flow properties.

By a periodic fluctuation one should understand, within the scope of the present invention, an alternating component of a signal which is generated by the periodic pressure waves of the compressor. The pressure waves are caused by the individual blades of the compressor.

By upstream of the compressor one should understand a position in an air supply channel which the air flowing in the main flow direction reaches sooner than it reaches the compressor. In this context, the position refers exclusively to an air supply channel and not to a position in a supply channel of an exhaust-gas recirculation.

Analogously, by downstream of the air filter one should understand a position in an air supply channel which the air flowing in the main flow direction reaches later than it reaches the air filter.

Within the scope of the present invention, one should understand by main flow direction the local flow direction of the fluid medium at the location of the sensor, whereby local irregularities, for example, are able to remain disregarded. Consequently, by main flow direction one may, in particular, understand the local averaged transport direction of the flowing fluid medium.

By an analog/digital conversion one should understand, within the scope of the present invention, the conversion of analog input signals into digital data, or a data flow which is then able to be processed further or stored. For this purpose, a so-called analog/digital converter is usually used. The analog/digital converter quantifies a continuous input signal, such as an electric voltage, both in time and in signal level.

Thereby, each signal, after conversion into a signal-time diagram, is represented by a point sequence having graded horizontal and vertical distances. The quantization means that a limited continuous range of values is converted to an equally limited but graded range of values. During the quantization, a variable, which was continuous before, assumes discrete values and thus values that may be separated in an isolated manner.

By a high-pass filter one should understand, within the scope of the present invention, a filter which allows signal portions having frequencies above its frequency limit to pass approximately unattenuated, and dampens portions having lower frequencies. The limiting frequency is that value of the frequency at whose exceeding the signal amplitude or the modulation amplitude at the output of a component falls below a certain value. In a simple RC or RL high-pass filter, the voltage transmission factor has the maximum value 1, for example. At the limiting frequency, the transmitted amplitude drops off to the

$$\frac{1}{\sqrt{2}}$$

fold value.

Analogously, by a low-pass filter one should understand, within the scope of the present invention, a filter which allows signal portions having frequencies below their limiting frequency approximately unattenuated, but dampens portions having higher frequencies.

By a Fourier transformation one should understand, within the scope of the present invention, a method of Fourier analysis which permits separating continuous signals into a continuous spectrum.

According to the present invention it is provided that the flow property and/or the pressure be recorded upstream of the compressor. In this context, the reading upstream of the compressor refers to a position in a supply channel for supplying air, particularly environmental air, to a combustion chamber of the internal combustion engine. In this context, the upstream reading is to be seen with respect to time, so that the air reaches first the position given and then the compressor. A basic idea of the present invention is that the rotating blades of the compressor generate pressure waves which spread out in the compressed air downstream from the compressor and in the environmental air, upstream of the compressor. Thus, it is the crux of the present invention to measure these pressure pulsations by a particularly also thermally suitable positioning of the pressure sensor downstream from an air filter and upstream of the compressor, and from this to determine the speed of the turbocharger using suitable means of signal processing. The periodic fluctuations may be recorded, in this case, by an air mass meter and/or a pressure sensor. The periodic fluctuations of both sensors named are then advantageously recorded. In this context, the signal processing in the sensor may then take place on the spot, in the engine control unit or in an additional component. Thus, a significant advantage of the present invention is that, besides the determination of the average pressure downstream from the air filter, which permits an accurate recording of the air filter charging state, in addition, a speed of the exhaust gas turbocharger is able to be determined, without this requiring an additional sensor. Compared to recording the speed using a pressure sensor downstream from the compressor, this has the advantage that only intake air having clearly lower temperatures reaches the pressure sensor and acts upon it, whereas a pressure sensor upstream of the compressor is exposed to comparatively high temperatures as a result of the air compression.

### BRIEF DESCRIPTION OF THE DRAWINGS

FIG. 1 shows a schematic representation of an internal combustion engine having an exhaust gas turbocharger and a pressure sensor.

FIG. 2 shows a schematic representation of a compressor and its output region.

FIG. 3 shows an additional schematic view of a compressor.

FIG. 4 shows a flow chart of a method for determining a speed of a compressor.

FIG. 5 shows a schematic representation of an internal combustion engine having an exhaust gas turbocharger and a pressure sensor according to a second specific embodiment of the present invention.

FIG. 6 shows an additional flow chart of a method for determining a speed of a compressor.

### DETAILED DESCRIPTION OF THE INVENTION

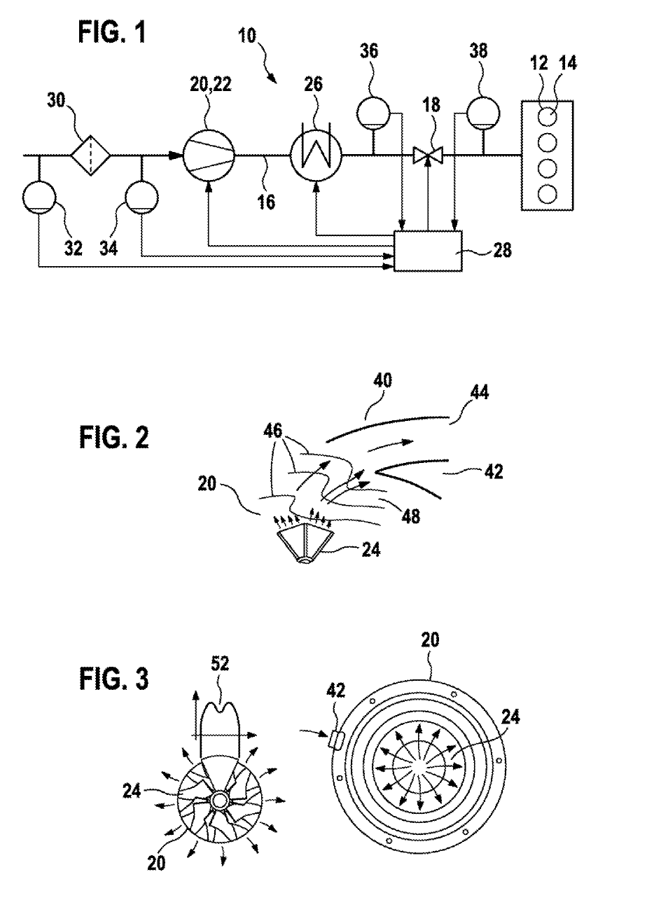

FIG. 1 shows an internal combustion engine 10. It is used to drive a motor vehicle (not shown). Internal combustion engine 10 may be developed as a gasoline internal combustion engine having manifold injection, a Diesel internal combustion engine or an internal combustion engine having direct fuel injection.

Internal combustion engine 10 includes a plurality of cylinders 12, which enclose a combustion chamber 14. Combustion air reaches combustion chamber 14 via an air supply channel 16 and through an inlet valve not shown in greater detail. Air supply channel 16 may be designed, for example, as an intake duct. Directly upstream of the intake valve, fuel is injected by an injector (not shown), which is connected to a fuel system. Upstream of the injector, there is a throttle valve 18 located in air supply channel 16.

A fuel-air mixture present in combustion chamber 14 is ignited by a spark plug, which is connected to an ignition system. Hot combustion exhaust gases are carried off from combustion chamber 14 through an exhaust valve and an exhaust pipe. A turbine is situated in the exhaust pipe.

A compressor 20 is further situated in air supply channel 16, which is mechanically connected to the turbine. The turbine and compressor 20 together form an exhaust gas turbocharger 22. To compress the air, compressor 20 has a plurality of compressor blades 24, as is shown, for example, in FIG. 2 or 3. The intake air heated by the compression is cooled by a charge-air cooler 26, which is situated in intake duct 16, between compressor 20 and throttle valve 18.

The operation of internal combustion engine 10 is controlled and/or regulated by a control and/or regulating device 28. In particular, throttle valve 18, the injector, the ignition system and the like are controlled by control and regulating device 28. To do this, control and/or regulating device 28 receives signals from various sensors. For instance, upstream of an air filter 30, which is situated upstream of compressor 20, there is located an environmental pressure sensor 32, between air filter 30 and the compressor a pressure sensor 34, between air charge cooler 26 and throttle valve 18 a charge pressure sensor 36 and between throttle valve 18 and combustion chamber 14 an additional pressure sensor 38 for determining the pressure of the throttled charge air. From a pressure signal of pressure sensor 34 and a signal of environmental pressure sensor 32, a pressure difference may be determined, and from this, a functional state of air filter 30 may be determined. Pressure sensors 32, 34, 36, 38 may be developed, for example, and may work as pressure sensors which are described in Konrad Reif (Publisher), Sensors in the Motor Vehicle, 1^{st} edition 2010, see pages 80-82 and 134-136.

The combustion air supplied to combustion chamber 14 is compressed by compressor 20, which makes possible a greater performance of internal combustion engine 10. The pressure of the air charge pressed into combustion chamber 14 is made available by pressure sensors 36 and 38 in a manner that will be shown in greater detail, and is adjusted in a closed control loop by control and regulating device 28.

In order to achieve regulation of the boost pressure that is as rapid and precise as possible, the boost pressure is regulated not only based on the boost pressure made available by pressure sensors 36, 38, but also based on the current rotational speed of compressor 20. Boost pressure p_{L} and rotational speed n_{ATL} are ascertained starting from a signal Uₚ that is made available by pressure sensor 34, with the aid of a method which will now be explained in greater detail, with reference to FIGS. 2 through 4.

FIG. 2 shows compressor 20 and a compressor blade 24 in exemplary fashion. In an axial compressor, for example, each time a compressor blade 24 passes a certain position, the speed, and thereby also the pressure of the conveyed air changes. This leads to periodic pressure fluctuations, whose periods are connected to the rotational speed of compressor 20. This connection is utilized, according to the present invention, to obtain the rotational speed of compressor 20. Basically, it was determined, for instance, using a knock sensor, that the pressure vibrations spread as structure-borne noise to a compressor housing 40. This is shown schematically, for example, in FIG. 2 on a compressor blade 42, which borders on an outlet 44 from compressor 20. In particular, FIG. 2 shows a static pressure distribution 46 and the spreading of pressure waves 48 to compressor housing 40. By these measurements, it has turned out, however, that the pressure vibrations also spread out upstream of compressor 20.

FIG. 3 shows schematically, for example, how an exemplary recorded structure-borne noise signal 50 looks over time in the area of compressor blade 42.

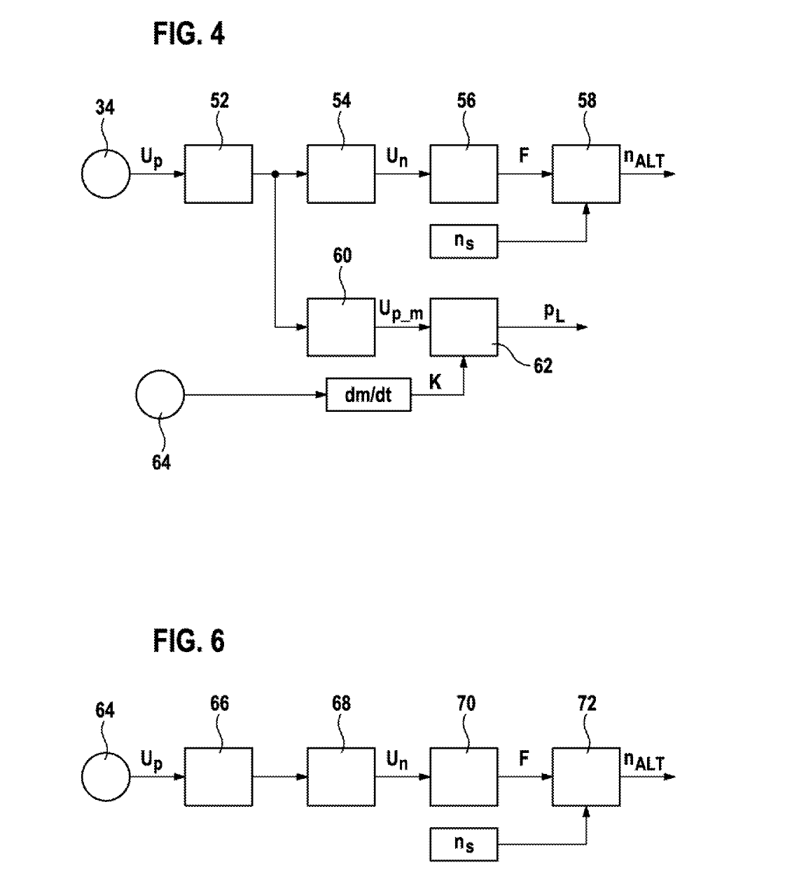

Now, according to the present invention, it is provided to determine a speed n_{ATL} of compressor 20 using pressure sensor 34 that is situated upstream of it. Speed n_{ATL} of compressor 20 is determined more accurately by an evaluation circuit that is not shown in greater detail. The evaluation circuit may be located in a control and/or regulating unit which has control and/or regulating device 28. Alternatively, the evaluation circuit may be located in a sensor housing for pressure sensor 34 or in a component separated from it. The corresponding method is schematically represented in FIG. 4. First of all, output signal Uₚ of pressure sensor 34 is submitted to an A/D conversion in step 52. Using a high-pass filter 54, periodic fluctuations Uₙ, i.e. alternating components of signal Uₚ are then separated. These periodic fluctuations Uₙ are brought about by the pressure waves of compressor 20, which are caused by the individual compressor blades 24 of compressor 20. In order for the periodic fluctuations Uₙ of pressure sensor 34 to be able to be recorded, it is necessary to situate it comparatively close to compressor 20, as shown in FIG. 1. Besides that, pressure sensor 34 has to have appropriate dynamics.

The periodic fluctuations separated by high-pass filter 54 are now submitted in step 56 to a Fourier transformation, by which frequency F of the periodic fluctuations is ascertained. This frequency F is the product of rotational speed n_{ATL} and the number nₛ of compressor blades 24. Therefore, in step 58, ascertained frequency F is divided by the number nₛ of compressor blades 24, which finally leads to rotational speed HAIL of compressor 20.

As was mentioned above, signal Uₚ of pressure sensor 34 is also used to ascertain boost pressure p_{L} which prevails immediately upstream of the intake valve and in combustion chamber 14 itself. For this purpose, signal Uₚ is submitted to a low-pass filtering in step 60, which leads to an average value Uₚ_{_{—}}ₘ of pressure signal Uₚ. This average value Uₚ_{_{—}}ₘ corresponds to the pressure between compressor 20 and charge air cooler 26. In order to obtain from this the pressure directly upstream of the intake valve, the value Uₚ_{_{—}}ₘ is submitted to a correction in step 62. For instance, value Uₚ_{_{—}}ₘ is acted upon multiplicatively or additively by a correction factor K. Correction factor K is determined during the design of the parameters of control and/or regulating device 40, for instance, on an engine test stand, by measuring the pressure before and after charge air cooler 26 at different operating states of internal combustion engine 10. Again, correction factor K may be a function of operating variables, for instance, of an air mass flow dm/dt, which is recorded by a hot film air mass meter 64. Alternatively, the pressure may also be determined using pressure sensor 38.

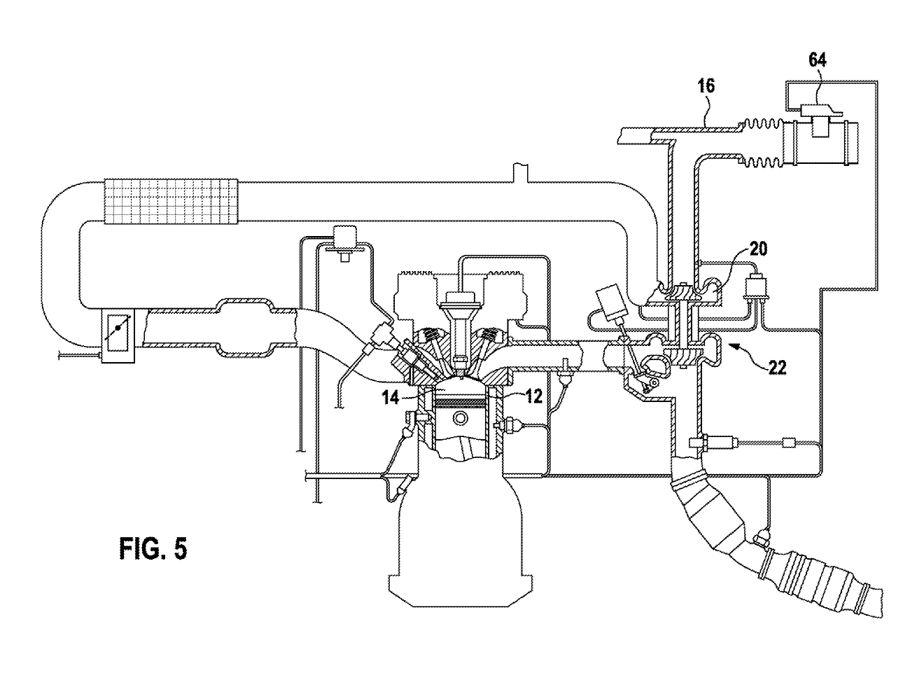

FIG. 5 shows a further possible specific embodiment of the present invention. From here on, only the differences from internal combustion engine 10 of the first specific embodiment are described, and identical components are provided with the same reference numerals.

In internal combustion engine 10 of the second specific embodiment, upstream of compressor 20, there is a so-called hot film air mass meter 62, as is described, for example in Konrad Reif (Publisher): Sensors in the Motor Vehicle, 1^{st} edition 2010, pages 156-158. Such hot film air mass meters 62 are based, as a rule, on a sensor chip, especially a silicon sensor chip, having a measuring surface over which the flowing fluid medium is able to flow. The sensor chip normally includes at least one heating element as well as at least two temperature sensors which are situated on the measuring surface of the sensor chip, for example. From an asymmetry of the temperature profile recorded by the temperature sensors, which is influenced by the flow of the fluid medium, one may draw a conclusion on a mass flow and/or a volume flow of the fluid medium.

Hot film air mass meters are usually designed as pluggable sensors which are able to be applied in a fixed manner or exchangeably in air supply channel 16.

Hot film air mass meter 62 is designed to record an air mass flow of an intake air flowing through air supply channel 16 and for generating a flow signal which indicates the air mass flow. Here too, compressor blades 24 generate a pressure pulse which is able to spread out upstream in air supply channel 16 to hot film air mass meters 62. This pressure pulse is periodic, and is able to be determined as a so-called rotational noise frequency. Because of the method mentioned above, the useful signal searched for is able to be separated from the interference signal with the aid of the air mass meter signal, as will be described in greater detail below with reference to FIG. 6. The speed of the compressor is more accurately determined by an evaluation circuit. The evaluation circuit may be located in a control and/or regulating unit which has control and/or regulating device 28. Alternatively, the evaluation circuit may be located in a sensor housing for hot film air mass meters 62 or in a component separated from it.

First of all, flow signal U_{LM} of air mass meter 62 is submitted to an A/D conversion (analog/digital conversion) in step 66. Using a high-pass filter 68, periodic fluctuations Uₙ, i.e. alternating components, of flow signal U_{LM} are separated. These periodic fluctuations Uₙ are brought about by the pressure waves of compressor 20, which are caused by the individual compressor blades 24 of compressor 20.

The periodic fluctuations separated by high-pass filter 68 are now submitted in step 70 to a Fourier transformation, by which frequency F of the periodic fluctuations is ascertained. This frequency F is the product of rotational speed n_{ATL} and the number nₛ of compressor blades 24. Therefore, in step 72, ascertained frequency F is divided by the number nₛ of compressor blades 24, which finally leads to rotational speed n_{ATL} of compressor 20.

If a sound propagation upstream of compressor 20 is not ensured, or only insufficiently so, for instance, because the speed of compressor 20 is too low or interfering effects are too great, the speed recording is undertaken conventionally, based on the measured average air pressure via the known modulation of the speed of compressor 20. The tolerance effects of this modulation on the speed are taken into account via appropriate safety distances. Air mass meter 62, in the relevant speed and frequency range, is able to record flow signals up to ca. 25 kHz.

What is conceivable is a combination of a speed determination of compressor 20 using the abovementioned pressure sensor 34 and the described air mass meter 62, since these increase the signal-to-noise ratio and assure the unambiguity of a separated signal portion. The above pressure sensor 34 may be integrated into the housing of air mass meter 62, for example. In this context, it should be observed that the useful signals are phase-displaced. In particular, the pressure signal is leading compared to the mass flow signal, which should be appropriately taken into account.

1-10. (canceled)

11. A method for determining a rotational speed of a turbocharger of an internal combustion engine, comprising:
recording at least one of a flow and a pressure of air supplied to the internal combustion engine and generating at least one of an associated flow signal and an associated pressure signal, wherein the at least one of the flow and the pressure is recorded upstream of the turbocharger; and
ascertaining the rotational speed of the compressor from a periodic fluctuation of at least one portion of the at least one of the flow signal and the pressure signal.

12. The method as recited in claim 11, wherein the internal combustion engine includes an air filter, and wherein the at least one of the flow and the pressure is recorded downstream from the air filter.

13. The method as recited in claim 12, wherein one of a pressure difference or a pressure ratio is determined from the pressure signal and a further pressure signal of an environmental pressure sensor, and a functional state of the air filter is determined from the one of the pressure difference or the pressure ratio.

14. The method as recited in claim 13, wherein the periodic fluctuation is separated from the at least one of the flow signal and the pressure signal by high-pass filtering.

15. The method as recited in claim 13, wherein a frequency of the periodic fluctuation is ascertained by a Fourier transformation.

16. The method as recited in claim 15, wherein the rotational speed of the compressor is obtained by a division of the frequency by a number of blades of the compressor.

17. The method as recited in claim 13, wherein the rotational speed of the compressor is ascertained from a periodic fluctuation of at least one portion of the flow signal and at least one portion of the pressure signal.

18. An internal combustion engine, comprising:
a compressor situated in an air supply channel for supplying air to a combustion chamber of the internal combustion engine;
at least one of (i) a pressure sensor for recording a pressure of the air supplied to the combustion chamber and for generating an associated pressure signal, and (ii) a flow sensor for recording a flow of air supplied to the combustion chamber and for generating an associated flow signal, wherein the at least one of the flow sensor and the pressure sensor is situated in the air supply channel upstream of the compressor; and
an evaluation circuit for determining a rotational speed of the compressor, wherein the rotational speed of the compressor is ascertained from a periodic fluctuation of at least one portion of the at least one of the flow signal and the pressure signal.

19. The internal combustion engine as recited in claim 18, wherein the evaluation circuit for determining the rotational speed of the compressor is situated in at least one of a control unit of the internal combustion engine, a sensor housing for the flow sensor, and a sensor housing of the pressure sensor.

20. The internal combustion engine as recited in claim 19, wherein both the flow sensor and the pressure sensor are included, and wherein the flow sensor and the pressure sensor are integrated into a common sensor housing.
